(19) United States
(12) Patent Application Publication
(10) Pub. No.: US 2019/0340567 A1
(43) Pub. Date: Nov. 7, 2019

(54) COMPUTER-IMPLEMENTED METHOD AND SYSTEM FOR TRACKING INVENTORY

(71) Applicant: Microsoft Technology Licensing, LLC, Redmond, WA (US)

(72) Inventors: Donna Katherine LONG, Redmond, WA (US); Kenneth Liam KIEMELE, Redmond, WA (US); Jennifer Jean CHOI, Seattle, WA (US); Jamie R. CABACCANG, Bellevue, WA (US); John Benjamin HESKETH, Kirkland, WA (US); Bryant Daniel HAWTHORNE, Duvall, WA (US); George Oliver JOHNSTON, Redmond, WA (US); Anthony ERNST, Woodinville, WA (US)

(73) Assignee: Microsoft Technology Licensing, LLC, Redmond, WA (US)

(21) Appl. No.: 16/019,417

(22) Filed: Jun. 26, 2018

Related U.S. Application Data
(60) Provisional application No. 62/667,387, filed on May 4, 2018.

(51) Int. Cl. G06Q 10/08; G10L 15/08; G06F 1/16; G06F 15/18; G06N 5/04; G06K 9/00

(52) U.S. Cl. CPC G06Q 10/087; G10L 15/08; G06K 9/00624; G06F 15/18; G06N 5/046; G06F 1/163

(57) ABSTRACT

A wearable computing device is provided, comprising a camera and a microphone operatively coupled to a processor. Using both camera image data and speech recognition data, an object is detected and classified as an inventory item and inventory event. The inventory item and inventory event are subsequently recorded into an inventory database. Classifiers used to determine the inventory item and inventory event from the image data and speech may be cross trained based on the relative confidence values associated with each.

### CROSS REFERENCE TO RELATED APPLICATIONS

This application claims priority to U.S. Provisional Patent Application Ser. No. 62/667,387, filed May 4, 2018, the entirety of which is hereby incorporated herein by reference for all purposes.

### BACKGROUND

Businesses often have a difficult time managing inventory. For example, workers in the restaurant industry often have trouble keeping track of the supplies of ingredients that are used to prepare menu items. Raw materials and/or items may be added for sale to inventory at receiving, raw material and finished product inventories may be adjusted at product manufacturing, and inventory may be reduced upon the sale of product. Poor inventory tracking may result in low inventories of ingredients and supplies being exhausted.

### SUMMARY

A computer-implemented method is provided for tracking inventory. The method may include the steps of capturing image data of an event including a series of images on a camera on a wearable computing device and capturing audio data of the event on a microphone on the wearable computing device. The method may further include performing speech recognition on the captured audio data to detect speech and classifying the speech using a speech classifier to determine that the event was an inventory event with a speech classification confidence value. The method may further include classifying the image data using an image classifier to determine that the event was an inventory event with an image classification confidence value. The method may further include cross training the speech classifier based on the image classification confidence value and/or cross training the image classifier based on the speech classification confidence value. The method may further include outputting the inventory event to an inventory program.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of a wearable computing device of the present description.

FIG. 2 shows a perspective view of the wearable computing device of FIG. 1.

FIG. 3 shows a computer system including the wearable computing device of FIG. 1, according to an embodiment of the present description.

FIG. 4 shows an example use scenario of the wearable computing device of FIG. 1, according to an embodiment of the present description.

FIG. 5 shows a computer-implemented method according to an embodiment of the present description.

FIG. 6 shows an example neural network that may be used to train a classifier used by the computer system of FIG. 3, according to an embodiment of the present description.

FIG. 7 shows an example computing system according to an embodiment of the present description.

### DETAILED DESCRIPTION

As described above, inventory tracking involves tracking the movement of raw materials and products into and out of a business. The inflow of materials and products is tracked during receiving, while the outflow is tracked, for example, via sales data and write-offs of expired/unusable materials/products. However, accurately tracking inventory may pose various challenges, as some removals of items from inventory may not be well-tracked. For example, a food service establishment may replace a spilled drink or a dropped food item for no charge, or remake an order to a customer's liking. Such inventory deducted from available supply but not recorded as a sale is referred to herein as a mark-out. An incident leading to a mark-out may happen in the moment, and an employee may be too busy or otherwise neglect to accurately record the mark-out for inventory tracking purposes. Mark-outs that are not recorded by employees are difficult to distinguish from thefts and the like when reviewing inventory records. Thus, it can be difficult for a business to accurately track product loss arising from such sources, and difficult to understand what remedial measures may be best. Further, existing solutions for inventory management often use different hardware for receiving/inventory tracking and point-of-sale, thereby requiring the business to purchase dedicated hardware for each, at possibly considerable expense.

One possible solution to such issues may be to use a voice-controlled computing device, such as a smart speaker, for an employee to use to verbally enter a mark-out when the mark-out incident occurs. Such a voice-controlled device also may be used for other inventory tracking, such as performing receiving and updating floor inventory counts. However, employee interactions with such a device may be inconvenient and somewhat disruptive to the customer experience, depending upon the location of the employee compared to the smart speaker location and customer locations. Further, persons other than intended users may tamper with the device via speech inputs.

In view of the above described problem, the present inventors have harnessed artificial intelligence, machine learning, speech recognition, and image object recognition technologies to increase the accuracy of inventory tracking in businesses. A wearable computing device is provided, comprising a camera and a microphone operatively coupled to a processor. Using both camera image data and speech recognition data, it is possible to increase inventory tracking accuracy, and also build machine learning training sets to increase the accuracy of the recognition of the image recognition system and speech recognition system. The microphone and cameras of the system could be implemented via a wearable computing device such as a tag or badge device, or in various separate devices positioned within a business environment, as described below.

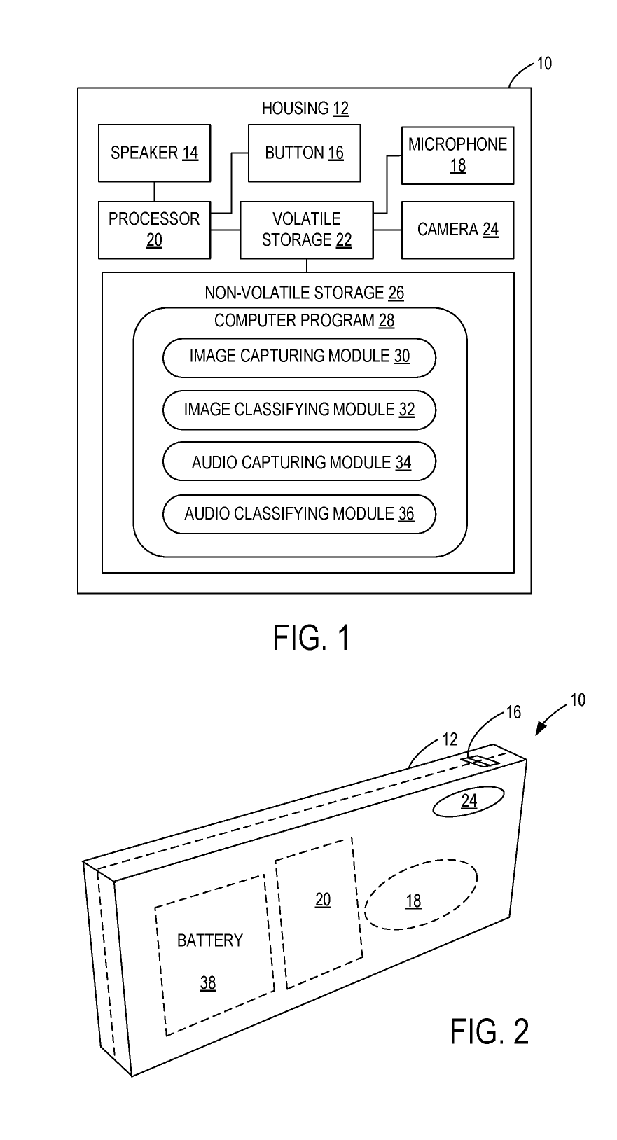

FIGS. 1 and 2 illustrate a wearable computing device 10 in the form of a badge, according to one embodiment of the present disclosure, which has been conceived to address the issues discussed above. As shown, the wearable computing device 10 includes a housing 12 which, for example, may take the form of a casing surrounding internal electronics and providing structure for a camera 24, a microphone 18, a push button 16, etc. The housing 12 is configured to include a processor 20, volatile storage device 22, non-volatile storage device 26, a microphone 18, a speaker 14, and a camera 24. The speaker 14 may be directional to enable the wearable device 10 to output sounds that are audible to a wearer but less perceptible to bystanders. The microphone 18 may be directional to reduce noise received from directions other than toward a user's mouth, and to lessen the risk of customers intentionally or incidentally making unwanted speech commands to the wearable device 10. In some examples, the wearable device 10 may include an additional microphone configured to detect ambient sounds for use in noise cancellation.

The processor 20 is configured to execute software programs stored in the non-volatile storage device 26 using portions of volatile storage device 22 to perform the various functions recited herein. In one example, the processor 20, volatile storage device 22, and non-volatile storage device 26 may be included in a system-on-chip configuration included in the wearable computing device 10. It will be appreciated that the wearable computing device 10 may also take the form of other types of wearable mobile computing devices, such as, for example, a head-mounted device, identification badge, lanyard, name tag, wrist band, earpiece, etc. The wearable computing device 10 may also have a rechargeable battery 38 or a plurality of batteries that is recharged when the wearable computing device 10 is docked onto a charging station (not shown) for connecting the wearable device 10 to a power supply for charging between uses. The rechargeable battery 38 or a plurality of batteries may contain sufficient charge for a desired use duration (e.g., the workday or shift). Further, in some scenarios, the components and functionalities of the wearable computing device 10 may be provided in a computing device that is not wearable, but is portable, mobile, or even mounted at a fixed location within the environment.

In the configuration illustrated in FIGS. 1 and 2, a camera 24 is provided on the wearable computing device 10 and configured to capture images of the surrounding physical environment of the computing device 10. In other embodiments, a plurality of cameras may be provided, although the precise number of cameras 24 may vary. The raw images from the cameras 24 may be stitched together with perspective correction to form a 360 degree view of the physical environment, in some configurations. Typically, cameras 24 are visible light cameras. Images from two or more of the cameras 24 may be compared to provide an estimate of depth, using passive stereo depth estimation techniques. The camera 24 may alternatively be configured as depth cameras using an active non-visible light illuminator and non-visible light sensor to emit light in a phased or gated manner and estimate depth using time-of-flight techniques, or to emit light in structured patterns and estimate depth using structured light techniques. Sill other configurations of the camera 24 may include RGB, LIDAR, and SONAR.

The processor 20 is configured to execute a computer program 28, which for example, may be an operating system or control program for the wearable computing device 10 stored on the non-volatile storage device 26, and to enact various control processes described herein. In some examples, the processor 20, volatile storage device 22, and non-volatile storage device 26 are included in a System-On-Chip configuration.

The computer program 28 executed on the processor 20 includes an image capturing module 30. As shown in FIG. 1, the image capturing module 30 is configured to receive image data from the camera, analyzing the image data, which may comprise video frames, to detect an object and an event of the object. The image data from the camera may be time stamped to be organized in chronological order in an inventory database. For example, the object may be a bagel, and the event of the object may be the act of the taking a bagel off of a shelf. Alternatively, the event of the object, or the inventory event, may encompass any number of incidents, observations, and happenings of the object, including a sale of the object, the receiving of the object, and mark-outs: discarding, dropping, or moving the bagel, spillage of milk, spoilage of items, etc. An image classifying module 32 classifies the detected object on the image or frame as an image-identified inventory item, and classifies the detected event as an image-identified inventory event of the image-identified inventory item using image machine learning classifiers using neural networks, implementing an image machine-learning algorithm that iteratively processes the detected image, location, data context information to inform and modify the algorithm over time. Thus, an image classification is obtained comprising the image-identified inventory item and the image-identified inventory event. The neural networks for the image classifying module 32 may include convolutional neural networks, for example. One example of a convolutional neural network that may be included in the image classifying module 32 may be a Regional Convolutional Neural Net (R-CNN), which may identify a location of an object in a frame and detect multiple objects in the same image or frame.

The audio capturing module 34 is configured to receive audio data from the microphone 18, and is configured to perform speech recognition on the captured audio data to detect speech. The speech recognition may be performed through natural language processing (NLP) either performed on the wearable computing device 10 or at a remote server through cloud-based NLP services. An audio classifying module 36 classifies the speech as a descriptor of a speech-identified inventory item using speech machine learning classifiers using neural networks, and further classifying the speech as a descriptor of a speech-identified inventory event of the speech-identified inventory item, implementing an audio machine-learning algorithm that iteratively processes the detected speech, location data, context information to inform and modify the algorithm over time. Thus, a speech classification is obtained comprising the speech-identified inventory item and the speech-identified inventory event. The neural networks for the audio classifying module 36 may include recurrent neural networks, for example.

The informing and modifying of the machine-learning algorithm is otherwise known as training the machine-learning algorithm. The speech machine-learning algorithm for the audio classifying module 36 is also known as a speech recognition model, while the image machine-learning algorithm for the image classifying module 32 is also known as an object detection model. The algorithms of such models may include fast Fourier transform, normalizing program (e.g., function), triplet loss program (e.g., function), and backpropagating algorithm. It will be appreciated that the machine-learning algorithms for the audio classifying module 36 and the image classifying module 32 may be cross-trained. That is, if the image classifying module 32 misclassifies an item or is unable to classify an item with a sufficiently high confidence level, the correct classification performed by the audio classifying module 36 is used to reclassify the item misclassified by the image classifying module 32. In turn, if the audio classifying module 36 misclassifies an item or is unable to classify an item with a sufficiently high confidence level, the correct classification performed by the image classifying module 32 is used to reclassify the item misclassified by the audio classifying module 36. A predetermined confidence level may be used to determine whether a computed confidence level is sufficiently high. In one particular example, a speech classifier may be cross trained based on an image classification confidence value that is high when the speech classifier confidence value is low, and/or an image classifier may be cross trained based on a speech classification confidence value when the image classifier confidence value is low and the speech classification confidence value is high. In this way, the accuracy of both models may be improved.

For example, if the sun rises and glare strikes the bagel case, it may be difficult to detect how many bagels there are with a camera. If the user can simply state that there are nine bagels, then it becomes possible to determine how many bagels are present based on a speech classifier output having a high confidence value, despite the glare that produced a low confidence value in the image classifier output. Thus, the audio classifying module 36 can correctly classify the item that the image classifying module 32 misclassified or could not classify with a sufficiently high confidence level. Likewise, if the user's voice is difficult for the audio capturing module 34 and/or the audio classifying module 36 due to any number of reasons (noisy environment, unfamiliar accents, etc.), the image classifier operating on image data from the camera may be able to detect the event. If the image classifier successfully detects the event, then it is possible to classify the audio with its proper intent. By cross training the speech classifier using the high confidence value from the image classifier, the next time the user dictates an inventory event in a similar way, the audio classifying module 36 will be better able to classify the speech correctly.

In another example, if the image classifying module 32 classifies an item as a bagel with a low confidence level of 5%, which is below a predetermined confidence level threshold of 10%, while the audio classifying module 36 classifies the item as a donut with a high confidence level of 80%, the image classifying module 32 is subsequently cross-trained by the audio classifying module 36 to associate the detected object as a donut with an elevated confidence level above the predetermined confidence level threshold.

The aforementioned computer program 28 is described as having an image capturing module 30 and an audio capturing module 34, but it will be appreciated that the computer program may alternatively send image data and audio data to a remote server instantiating an image capturing module and an audio capturing module, and receive from the remote server classification data of a detected object and a detected event of the detected object, as further described below.

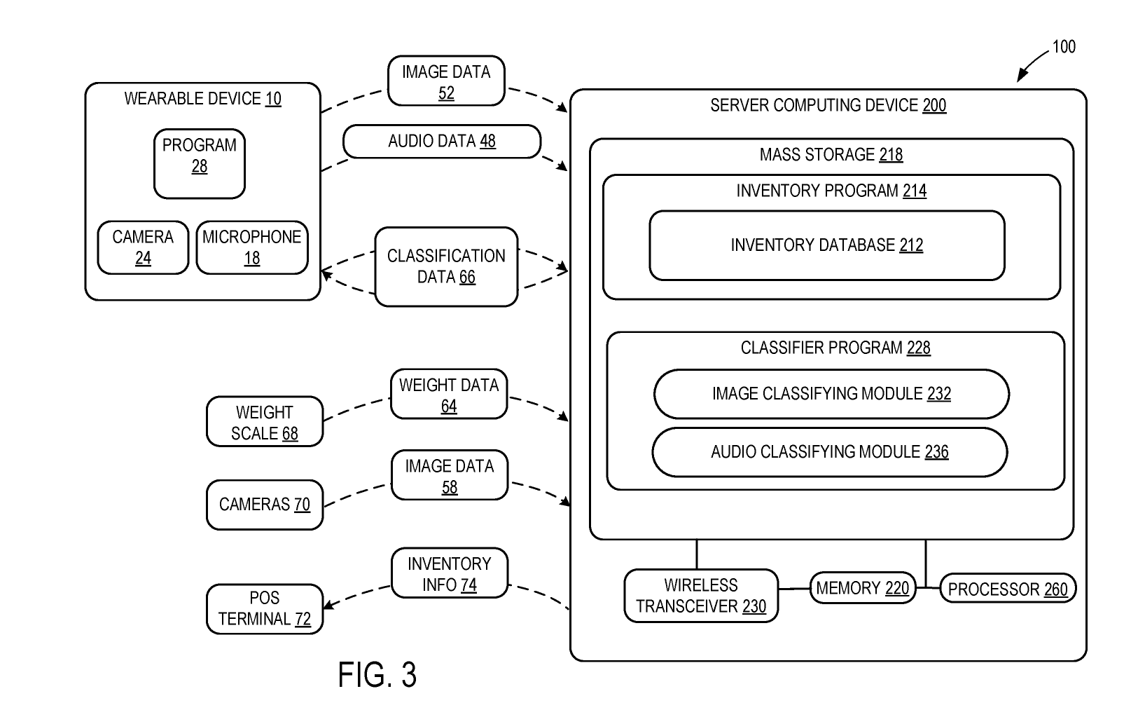

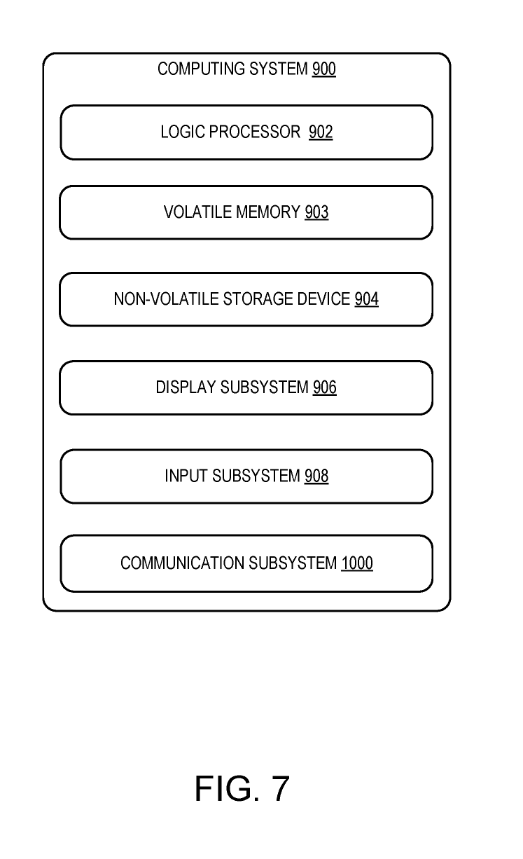

FIG. 3 is a schematic illustration of a server computing device 200 interacting with the badge according to an embodiment of the present disclosure. An example hardware configuration for the server device 200 is described in more detail below with respect to FIG. 7. The server computing device 200 may include an inventory program 214 that may be stored in mass storage 218 of the computing device 200. The inventory program 214 may be loaded into memory 220 and executed by a processor 260 of the server computing device 200 to perform one or more of the methods and processes for recording an inventory item and inventory event into the inventory database 212 responsive to classifying recognized speech and/or detected object as and an inventory item and inventory event. In certain embodiments where a classifier program 228 comprising an image classifying module 232 and an audio classifying module 236 is executed by the processor 260 of the server computing device 200, the server computing device 200 may be configured with a wireless transceiver 230 that wirelessly communicates with the wearable device 10 to receive image data 52 and audio data 48 from the wearable device 10 and transmits to the wearable device 10 classification data 66 identifying an inventory item and inventory event. In other embodiments, where the program 28 of the wearable device 10 is executed to classify recognized speech and/or a detected object as an inventory item and inventory event, image data 52 and/or audio data 48 may only be sent to the server computing device 200 when there is a discrepancy in the classifications made by the audio classifying module 36 and the image classifying module 32, or if at least one of the classifications has a low confidence level (below a predetermined confidence level threshold, for example), or image data 52 and/or audio data 48 may alternatively not be sent to the server computing device 200 at all. In such embodiments, the wearable device 10 may send classification data 66 identifying an inventory item and inventory event to be recorded into the inventory database 212, which tallies counts of inventory items and inventory events (increments, decrements, spillage, discards, moves, spoilage, etc.) associated with them.

The server computing device 200 may be communicatively coupled to one or more other devices via a wired connection or a wireless connection to a network. In some examples, the network may take the form of a local area network (LAN), wide area network (WAN), wired network, wireless network, personal area network, or a combination thereof, and may include the Internet. Such communication may be via a network or via a local communication hub (e.g. a charging station/hub for wearable devices). Example communication protocols include Bluetooth, Wi-Fi, RFID, and ultrasonic transmission. In the example of FIG. 3, server computing device 200 may be communicatively coupled to the wearable computing device 10 and other devices via one or more networks. The other devices may include one or more Internet of Things (IoT) devices that communicate with the wearable computing device 10 and the server computing device 200. Such devices may include cameras 70 placed on enclosures where inventory items are stored, such as cabinets and shelves, weight scales 68 placed beneath the surfaces on which inventory items are stored, so that differences in weights can suggest a decrement of inventory. In such cases, the server computing device 200 receives weight data 64 from the weight scale 68 and image data 58 from other cameras 70. In other examples the server computing device 200 may be operatively connected with fewer or additional devices.

The inventory database 212 may track inventory items over time, noting the time at which an inventory item was decremented. For example, it may be recorded in the inventory database 212 that many more orders of coffee are processed in the morning from 9 am to 10 am than any other times of the day. Accordingly, the server computing device may also be communicatively coupled to point-of-service (POS) computer terminals 72 that receive inventory information 74 from the server computing device 200 and order inventory items in real-time to be supplied to the store based on the rate at which inventory items are decremented.

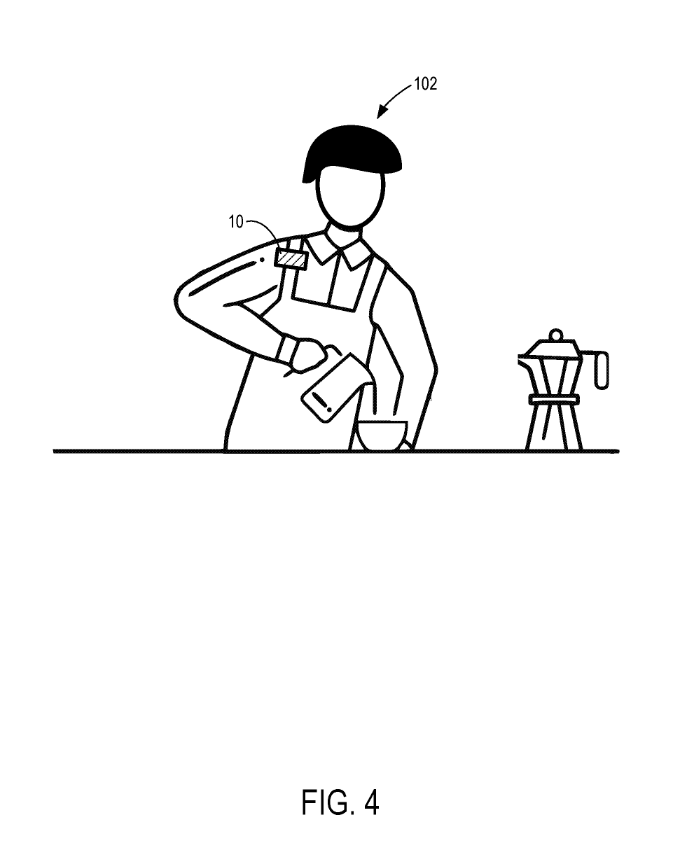

With reference to FIG. 4, an example use case illustrating aspects of the present disclosure will now be presented. A barista 102 may be working in a coffee store wearing a wearable computing device 10 which is embodied as a badge having a microphone, a camera, and a push button as shown in FIGS. 1 and 2. Other employees (not shown) in the store may be wearing other similar wearable computing devices, each having a microphone and a camera, each wearable device communicatively coupled to the same server computing device storing the inventory database. The plurality of wearable computing devices may be configured to operate within a spatial boundary defining a physical environment in which the one or more wearable devices may be used. The term “spatial boundary” refers to a place of work, such as a jobsite, a physical store location, a warehouse, an office, etc., and in some cases may not correspond to an actual physical boundary, but rather to a communication range of devices operating in the workspace.

The microphone receives the voice dictations of the barista 102, while the camera captures images of inventory items that the barista 102 handles, such as beverages and pastries. The barista 102 pushes the push button, prompting the audio capturing module 34 to be ready to capture voice audio from the barista 102. The barista 102 dictates an inventory item and an action that will be performed on the inventory item. For example, the barista 102 dictates “Hey device, mark out one coffee.” At the same time, the camera on the badge captures an image of an object, which is detected and classified as coffee by the image classifying module 32. An object may include a visible tag, such as an AprilTag, QR code, or bar code for ease of detection by the camera. The audio classifying module 36 classifies this speech as indicating that one cup of coffee has been marked out (taken out of inventory). The image classifying module 32 classifies the detected image as indicating that one cup of coffee has been prepared by the barista 102. The inventory database 212 is subsequently updated by the inventory program 214, decrementing the inventory count of coffee.

The push button 16, which a user may press when speaking into the microphone 18, may include a capacitive touch sensor. Signals from the push button 16 may cue the computer program 28 to start capturing images and audio for classification. In other examples, other activation mechanisms may be used in place of the push button 16, such as a capacitive touch sensor, thermal sensor, resistive touch sensor, or photo sensor. Further, the wearable device 10 may provide a positive confirmation of the completion of the image recognition or speech recognition to the user 102, for example, by emitting audio, haptic, and/or light feedback via one or more output devices of the wearable device. For example, the speaker 14 may emit an audible signal to indicate to the user that image recognition or speech recognition has completed. The positive confirmation may encourage continued use and increase user confidence in the technology, and may be output whether or not the input is actually understood by the inventory management computing system to encourage use of the device. It will be appreciated that the examples listed above are exemplary, and that other types of sensors not specifically mentioned above may also be included in as sensor devices of the mobile computing device 10.

In this example, user 102 is described as both pressing a button to activate the wearable device 10 and uttering the phrase “Hey Device,” prior to entering the inventory mark-out command. The use of a button 16 press to initiate a user input may help prevent customers or other people from speaking to the wearable device 10 and entering unwanted/incorrect commands. Further, as the button press is used for activation, the “Hey Device” utterance may have no command effect on the device, but instead serve as a social cue. As more detail, because the electronic functionality of the wearable device 10 is inconspicuous, customers may not understand that user 102 is entering a computing device command via speech. As such, by prefacing the command with the “Hey Device” utterance, which is similar to commands used by personal digital assistants as wake phrases, user 102 may signal that he or she is not speaking to others nearby, but rather to a device. Further, the use of such a preface phrase may help with speech recognition, as it may reduce a risk that the intended command is not fully recorded (e.g. any recording lag will not miss the actual command, but only a portion of the preface phrase). While the example of FIG. 4 uses a formal command structure to input the inventory mark-off command, a wearable device also may be configured to detect a signal from ordinary speech (e.g., an exclamatory phrase upon dropping the drink) via natural language processing.

In some examples, the wearable devices may not be associated with specific users. As such, inventory tracking inputs are not attributed to specific users in those examples. In other examples, some form of user authentication or association may be used to allow specific inventory tracking inputs to be attributed to specific users. In either instance, a user also may have the ability to enter additional information besides the nature of the mark-out, such as an additional speech input comprising an explanation of the mark-out to be stored as an annotation to the mark-out (e.g. explaining that a customer wanted an item remade, an item was dropped, etc.).

In some examples, sensor information from a wearable device may be used to locate the wearable device in an environment and store the location with an inventory tracking input. Such a location determination may be performed locally on the wearable device, or remotely on a computing system that receives information from the wearable device. Any suitable data may be used to locate a wearable device an environment. As one example, a wearable device may include one or more infrared light-emitting diodes detectable by cameras in the work environment. As another example, a location may be determined based on wireless network connections (e.g. Bluetooth or Wi-Fi data), via global positioning system (GPS) data, and/or via image data from an integrated image sensor of the wearable device that captures image data of known markers within the use environment. As yet another example, a wearable device may include an ultrasonic transmitter and an ultrasonic receiver to generate and receive reflections of sound waves in the ultrasonic range, or to provide sound waves to and receive sound waves from other ultrasonic transmitter/receivers in the environment.

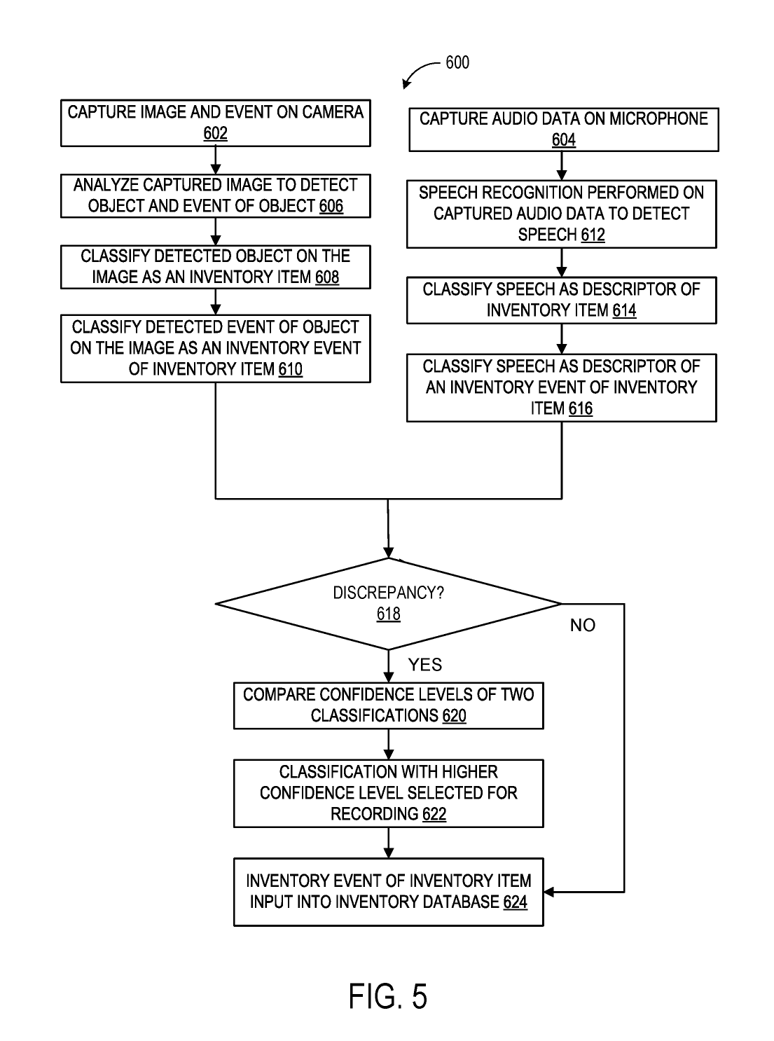

FIG. 5 illustrates a flow chart of a first method 600 for tracking inventory. At step 602, an image is captured on a wearable computing device. At step 604, audio data is captured on a microphone on the wearable computing device. At step 606, the captured image is analyzed to detect an object and an event of the object. At step 608, the detected object on the image is classified as an image-identified inventory item using image machine learning classifiers using neural networks. At step 610, the event of the object on the image is classified as an image-identified inventory event of the image-identified inventory item using image machine learning classifiers using neural networks. At step 612, speech recognition on the captured audio data is performed to detect speech. At step 614, the speech is classified as a descriptor of a speech-identified inventory item using speech machine learning classifiers using neural networks. At step 616, the speech is classified as a speech-identified inventory event of the speech-identified inventory item using speech machine learning classifiers using neural networks. At step 618, the speech classification of the inventory item and inventory event based on recognized speech is compared to the image classification of the inventory item and inventory event based on the image. It is determined whether or not there is a discrepancy between the two classifications. At step 620, when there is a discrepancy between the two classifications, the confidence levels of the two classifications are compared. At step 622, the classification with the higher confidence level is considered the most correct classification, selected to be recorded into the inventory database 212, and used to train the machine algorithm for the classification with the lower confidence level. For example, when the confidence level of the speech classification is higher than the confidence level of the image classification, the speech machine learning classifiers are trained to reinforce an association of the speech to the speech-identified inventory item and the speech-identified inventory event, and the image machine learning classifiers are trained to enforce an association of the detected object to the speech-identified inventory item and the detected event to the speech-identified inventory event. Likewise, when the confidence level of the image classification is higher than the confidence level of the speech classification, the image machine learning classifiers are trained to reinforce an association of the detected object to the image-identified inventory item and the detected event to the image-identified inventory event, and the speech machine learning classifiers are trained to enforce an association of the speech to the image-identified inventory item and the image-identified inventory event. At step 624, the inventory event of the inventory item corresponding to the classification with the higher confidence level is recorded into an inventory database 212.

Even when no discrepancy is found between the speech classification and the image classification, the machine learning classifiers may be updated to increase the accuracy of the machine learning classifiers. For example, the image machine learning classifiers may be trained to reinforce an association of the detected object to the image-identified inventory item and an association of the detected event to the identified inventory event, and the speech machine learning classifiers may be trained to reinforce an association of the descriptor to the speech-identified inventory item and the speech-identified inventory event.

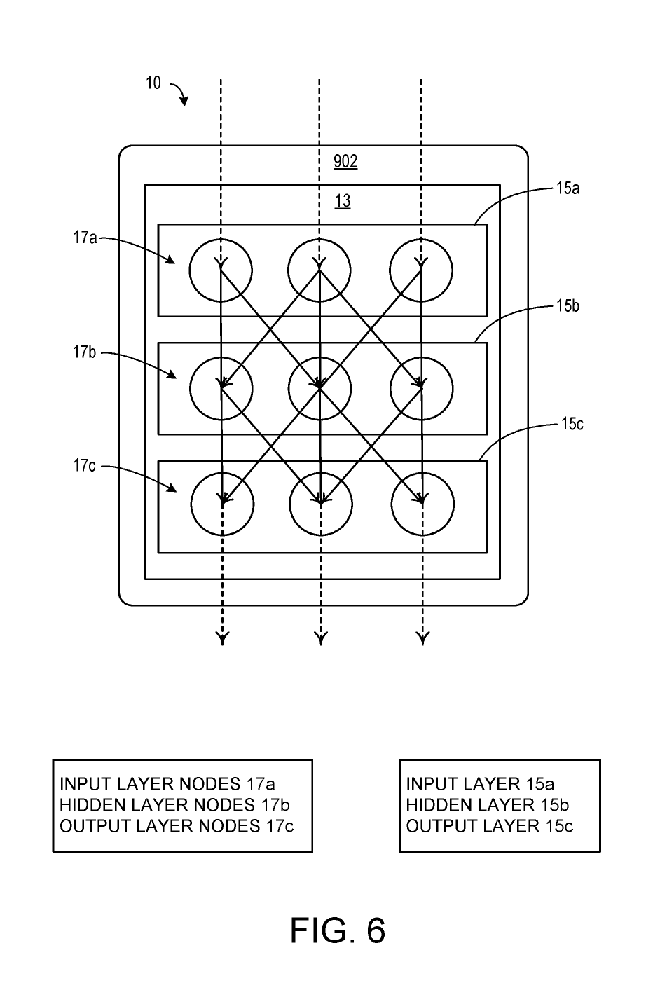

The method 600 also comprises executing a machine learning algorithm (machine learning algorithm means) for classifying an inventory item and an inventory event based on captured image data of a detected object and recognized speech from captured audio data from a microphone. Turning to FIG. 6, the neural network 13, having a plurality of layers 15 on the individual and crowd behavior data, is implemented by one or more logic processors 902. As demonstrated by the arrows in FIG. 6, the flow of data is unidirectional with no feedback to the input. Each layer 15 comprises one or more nodes 17, otherwise known as perceptrons or “artificial neurons.” The layers 15 may comprise an input layer 15a with input layer nodes 17a, an intermediate hidden layer 15b with hidden layer nodes 17b, and an output layer 15c with output layer nodes 17c. Each node 17 accepts multiple inputs and generates a single output signal which branches into multiple copies that are in turn distributed to the other nodes as input signals. The output layer nodes 17c are feature detectors configured to detect one or more features, each of which may be associated with statistical weights for each parameter input to the output layer node 17c. A feature in an image may include edges, lines, and corners, for example. A feature in audio data may be included in processed audio samplings. Each output layer node 17c may function as a processing node, and one or more nodes may be implemented by a processor 902. Further, a memory, operatively coupled to the processor 902, may be provided for storing learned weights for each output layer node 17c. During training, the neural network learns optimal statistical weights for each output layer node 17c, so that the corresponding sets of weights for the features detected by the one or more feature detectors are adjusted with each iterative repetition of the method 600. In this embodiment, three layers 15a, 15b, and 15c are depicted, and three nodes are provided for each layer, but it will be appreciated that the invention is not limited to these, and any number of layers may be provided for the neural network 13, and any number of nodes may be provided for each layer. Statistical weights may correspond to confidence levels.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 7 schematically shows a non-limiting embodiment of a computing system 900 that can enact one or more of the methods and processes described above. Computing system 900 is shown in simplified form. Computing system 900 may embody the computer device 10 or server computing device 200 described above and illustrated in FIGS. 1-3. Computing system 900 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 900 includes a logic processor 902, volatile memory 903, and a non-volatile storage device 904. Computing system 900 may optionally include a display subsystem, input subsystem, communication subsystem, and/or other components not shown in FIG. 7.

Logic processor 902 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 902 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 904 includes one or more physical devices configured to hold instructions executable by the logic processors to implement the methods and processes described herein. When such methods and processes are implemented, the state of non-volatile storage device 904 may be transformed—e.g., to hold different data.

Non-volatile storage device 904 may include physical devices that are removable and/or built-in. Non-volatile storage device 904 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 904 may include nonvolatile, dynamic, static, read/write, read-only, sequential-access, location-addressable, file-addressable, and/or content-addressable devices. It will be appreciated that non-volatile storage device 904 is configured to hold instructions even when power is cut to the non-volatile storage device 904.

Volatile memory 903 may include physical devices that include random access memory. Volatile memory 903 is typically utilized by logic processor 902 to temporarily store information during processing of software instructions. It will be appreciated that volatile memory 903 typically does not continue to store instructions when power is cut to the volatile memory 903.

Aspects of logic processor 902, volatile memory 903, and non-volatile storage device 904 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 900 typically implemented in software by a processor to perform a particular function using portions of volatile memory, which function involves transformative processing that specially configures the processor to perform the function. Thus, a module, program, or engine may be instantiated via logic processor 902 executing instructions held by non-volatile storage device 904, using portions of volatile memory 903. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 906 may be used to present a visual representation of data held by non-volatile storage device 904. The visual representation may take the form of a graphical user interface (GUI). As the herein described methods and processes change the data held by the non-volatile storage device, and thus transform the state of the non-volatile storage device, the state of display subsystem 906 may likewise be transformed to visually represent changes in the underlying data. Display subsystem 906 may include one or more display devices utilizing virtually any type of technology. Such display devices may be combined with logic processor 902, volatile memory 903, and/or non-volatile storage device 904 in a shared enclosure, or such display devices may be peripheral display devices.

When included, input subsystem 908 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 1000 may be configured to communicatively couple various computing devices described herein with each other, and with other devices. Communication subsystem 1000 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 900 to send and/or receive messages to and/or from other devices via a network such as the Internet.

The following paragraphs provide additional support for the claims of the subject application. One aspect provides a computer-implemented method for tracking inventory, comprising the steps of capturing image data of an event including a series of images on a camera on a wearable computing device; capturing audio data of the event on a microphone on the wearable computing device; performing speech recognition on the captured audio data to detect speech; classifying the speech using a speech classifier to determine that the event was an inventory event with a speech classification confidence value; classifying the image data using an image classifier to determine that the event was an inventory event with an image classification confidence value; cross training the speech classifier based on the image classification confidence value and/or cross training the image classifier based on the speech classification confidence value; and outputting the inventory event to an inventory program.

Another aspect provides computer-implemented method for tracking inventory, comprising the steps of capturing image data including a series of images on a camera on a wearable computing device; capturing audio data on a microphone on the wearable computing device; performing speech recognition on the captured audio data to detect speech; using a speech machine learning classifier to classify the speech as a descriptor of a speech-identified inventory item, and further to classify the speech as a descriptor of a speech-identified inventory event of the speech-identified inventory item, thereby obtaining a speech classification comprising the speech-identified inventory item and the speech-identified inventory event; analyzing the images to detect an object involved in an event; using an image machine learning classifier to classify the object as an image-identified inventory item, and further to classify the event as an image-identified inventory event of the image-identified inventory item, thereby obtaining an image classification comprising the image-identified inventory item and the image-identified inventory event; determining an inventory event for an inventory item based upon the image-identified inventory item and the image-identified inventory event and the speech-identified inventory item and the speech-identified inventory event; and outputting the inventory event and inventory item to an inventory program. The method may additionally or optionally include wherein the speech-identified inventory event includes at least one of an increment and a decrement of the speech-identified inventory item. The method may additionally or optionally include wherein the image-identified inventory event includes at least one of an increment and a decrement of the image-identified inventory item. The method may additionally or optionally include comparing the speech classification of the speech-identified inventory event and the speech-identified inventory item with the image classification of the image-identified inventory event and the image-identified inventory item, and determining whether or not there is a discrepancy between the speech classification and the image classification. The method may additionally or optionally include when it is determined that a discrepancy exists, comparing confidence levels of the speech classification and the image classification. The method may additionally or optionally include when the confidence level of the speech classification is higher than the confidence level of the image classification, training the speech machine learning classifier to reinforce an association of the speech to the speech-identified inventory item and the speech-identified inventory event, and training the image machine learning classifier to enforce an association of the detected object to the speech-identified inventory item and the detected event to the speech-identified inventory event. The method may additionally or optionally include when the confidence level of the image classification is higher than the confidence level of the speech classification, training the image machine learning classifiers to reinforce an association of the detected object to the image-identified inventory item and the detected event to the image-identified inventory event, and training the speech machine learning classifier to enforce an association of the speech to the image-identified inventory item and the image-identified inventory event. The method may additionally or optionally include when it is determined that no discrepancy exists, training the image machine learning classifier to reinforce an association of the detected object to the image-identified inventory item and an association of the detected event to the image-identified inventory event, and training the speech machine learning classifier to reinforce an association of the descriptor to the speech-identified inventory item and the speech-identified inventory event. The method may additionally or optionally include wherein a recurrent neural network is used to train the speech machine learning classifier that classifies the speech as the descriptor of the speech-identified inventory item, and that classifies the speech as the descriptor of the speech-identified inventory event of the speech-identified inventory item. The method may additionally or optionally include wherein a convolutional neural network is used to train the image machine learning classifier that classifies the detected object on the image as the image-identified inventory item, and that classifies the detected event as the image-identified inventory event of the image-identified inventory item. The method may additionally or optionally include wherein the wearable computing device is a badge including a housing that houses the microphone and camera. The method may additionally or optionally include wherein the wearable computing device communicates the image data and the audio data to a server computing device. The method may additionally or optionally include wherein the speech machine learning classifier and the image machine learning classifier are executed on the server computing device. The method may additionally or optionally include wherein the inventory program is executed on the server computing device.

The present disclosure further includes the following aspects. According to one aspect, a computer-implemented method for tracking inventory is disclosed, the method including the steps of capturing image data of an event including a series of images on a camera on a wearable computing device; capturing audio data of the event on a microphone on the wearable computing device; performing speech recognition on the captured audio data to detect speech; classifying the speech using a speech classifier to determine that the event was an inventory event with a speech classification confidence value; classifying the image data using an image classifier to determine that the event was an inventory event with an image classification confidence value; cross training the speech classifier based on the image classification confidence value and/or cross training the image classifier based on the speech classification confidence value; and outputting the inventory event to an inventory program.

According to another aspect of the present disclosure, a computer-implemented method for tracking inventory is disclosed, the method including the steps of capturing image data including a series of images on a camera on a wearable computing device; capturing audio data on a microphone on the wearable computing device; performing speech recognition on the captured audio data to detect speech; using a speech machine learning classifier to classify the speech as a descriptor of a speech-identified inventory item, and further to classify the speech as a descriptor of a speech-identified inventory event of the speech-identified inventory item, thereby obtaining a speech classification comprising the speech-identified inventory item and the speech-identified inventory event; analyzing the images to detect an object involved in an event; using an image machine learning classifier to classify the object as an image-identified inventory item, and further to classify the event as an image-identified inventory event of the image-identified inventory item, thereby obtaining an image classification comprising the image-identified inventory item and the image-identified inventory event; determining an inventory event for an inventory item based upon the image-identified inventory item and the image-identified inventory event and the speech-identified inventory item and the speech-identified inventory event; and outputting the inventory event and inventory item to an inventory program. In this aspect, the speech-identified inventory event may include at least one of an increment and a decrement of the speech-identified inventory item. In this aspect, the image-identified inventory event includes at least one of an increment and a decrement of the image-identified inventory item. In this aspect, the method may further include comparing the speech classification of the speech-identified inventory event and the speech-identified inventory item with the image classification of the image-identified inventory event and the image-identified inventory item, and determining whether or not there is a discrepancy between the speech classification and the image classification. In this aspect, the method may further include when it is determined that a discrepancy exists, comparing confidence levels of the speech classification and the image classification. In this aspect, the method may further include when the confidence level of the speech classification is higher than the confidence level of the image classification, training the speech machine learning classifier to reinforce an association of the speech to the speech-identified inventory item and the speech-identified inventory event, and training the image machine learning classifier to enforce an association of the detected object to the speech-identified inventory item and the detected event to the speech-identified inventory event. In this aspect, the method may further include when the confidence level of the image classification is higher than the confidence level of the speech classification, training the image machine learning classifier to reinforce an association of the detected object to the image-identified inventory item and the detected event to the image-identified inventory event, and training the speech machine learning classifier to enforce an association of the speech to the image-identified inventory item and the image-identified inventory event. In this aspect, the method may further include when it is determined that no discrepancy exists, training the image machine learning classifier to reinforce an association of the detected object to the image-identified inventory item and an association of the detected event to the image-identified inventory event, and training the speech machine learning classifier to reinforce an association of the descriptor to the speech-identified inventory item and the speech-identified inventory event. In this aspect, a recurrent neural network may be used to train the speech machine learning classifier that classifies the speech as the descriptor of the speech-identified inventory item, and that classifies the speech as the descriptor of the speech-identified inventory event of the speech-identified inventory item. In this aspect, a convolutional neural network may be used to train the image machine learning classifier that classifies the detected object on the image as the image-identified inventory item, and that classifies the detected event as the image-identified inventory event of the image-identified inventory item. In this aspect, the wearable computing device may be a badge including a housing that houses the microphone and camera. In this aspect, the wearable computing device may communicate the image data and the audio data to a server computing device. In this aspect, the speech machine learning classifier and the image machine learning classifier may be executed on the server computing device. In this aspect, the inventory program may be executed on the server computing device.

In another aspect, a system for tracking inventory is disclosed, the system including a wearable computing device including a processor, a microphone operatively coupled to the processor, and a camera operatively coupled to the processor, the processor being configured to capture image data of an event including a series of images on the camera; capture audio data of the event on the microphone; perform speech recognition on the captured audio data to detect speech; classify the speech using a speech classifier to determine that the event was an inventory event with a speech classification confidence value; classify the image data using an image classifier to determine that the event was an inventory event with an image classification confidence value; cross train the speech classifier based on the image classification confidence value and/or cross training the image classifier based on the speech classification confidence value; and output the inventory event to an inventory program. In this aspect, the image classifier may be an image machine learning classifier configured to classify the object as an image-identified inventory item, and further to classify the event as an image-identified inventory event of the image-identified inventory item, thereby obtaining an image classification comprising the image-identified inventory item and the image-identified inventory event. In this aspect, a convolutional neural network may be used to train the image machine learning classifier that classifies the detected object on the image as the image-identified inventory item, and that classifies the detected event as the image-identified inventory event of the image-identified inventory item. In this aspect, the speech classifier may be a speech machine learning classifier configured to classify the speech as a descriptor of a speech-identified inventory item, and further to classify the speech as a descriptor of a speech-identified inventory event of the speech-identified inventory item, thereby obtaining a speech classification comprising the speech-identified inventory item and the speech-identified inventory event. In this aspect, a recurrent neural network may be used to train the speech machine learning classifier that classifies the speech as the descriptor of the speech-identified inventory item, and that classifies the speech as the descriptor of the speech-identified inventory event of the speech-identified inventory item. Any or all of the above-described examples may be combined in any suitable manner in various implementations.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computer-implemented method for tracking inventory, comprising the steps of:
capturing image data of an event including a series of images on a camera on a wearable computing device;
capturing audio data of the event on a microphone on the wearable computing device;
performing speech recognition on the captured audio data to detect speech;
classifying the speech using a speech classifier to determine that the event was an inventory event with a speech classification confidence value;
classifying the image data using an image classifier to determine that the event was an inventory event with an image classification confidence value;
cross training the speech classifier based on the image classification confidence value and/or cross training the image classifier based on the speech classification confidence value; and
outputting the inventory event to an inventory program.

2. A computer-implemented method for tracking inventory, comprising the steps of:
capturing image data including a series of images on a camera on a wearable computing device;
capturing audio data on a microphone on the wearable computing device;
performing speech recognition on the captured audio data to detect speech;
using a speech machine learning classifier to classify the speech as a descriptor of a speech-identified inventory item, and further to classify the speech as a descriptor of a speech-identified inventory event of the speech-identified inventory item, thereby obtaining a speech classification comprising the speech-identified inventory item and the speech-identified inventory event;
analyzing the images to detect an object involved in an event;
using an image machine learning classifier to classify the object as an image-identified inventory item, and further to classify the event as an image-identified inventory event of the image-identified inventory item, thereby obtaining an image classification comprising the image-identified inventory item and the image-identified inventory event;
determining an inventory event for an inventory item based upon the image-identified inventory item and the image-identified inventory event and the speech-identified inventory item and the speech-identified inventory event; and
outputting the inventory event and inventory item to an inventory program.

3. The computer-implemented method of claim 2, wherein
the speech-identified inventory event includes at least one of an increment and a decrement of the speech-identified inventory item.

4. The computer-implemented method of claim 2, wherein
the image-identified inventory event includes at least one of an increment and a decrement of the image-identified inventory item.

5. The computer-implemented method of claim 2, further comprising:
comparing the speech classification of the speech-identified inventory event and the speech-identified inventory item with the image classification of the image-identified inventory event and the image-identified inventory item, and determining whether or not there is a discrepancy between the speech classification and the image classification.

6. The computer-implemented method of claim 5, further comprising:
when it is determined that a discrepancy exists, comparing confidence levels of the speech classification and the image classification.

7. The computer-implemented method of claim 6, further comprising:
when the confidence level of the speech classification is higher than the confidence level of the image classification, training the speech machine learning classifier to reinforce an association of the speech to the speech-identified inventory item and the speech-identified inventory event, and training the image machine learning classifier to enforce an association of the detected object to the speech-identified inventory item and the detected event to the speech-identified inventory event.

8. The computer-implemented method of claim 7, further comprising:
when the confidence level of the image classification is higher than the confidence level of the speech classification, training the image machine learning classifier to reinforce an association of the detected object to the image-identified inventory item and the detected event to the image-identified inventory event, and training the speech machine learning classifier to enforce an association of the speech to the image-identified inventory item and the image-identified inventory event.

9. The computer-implemented method of claim 5, further comprising:
when it is determined that no discrepancy exists, training the image machine learning classifier to reinforce an association of the detected object to the image-identified inventory item and an association of the detected event to the image-identified inventory event, and training the speech machine learning classifier to reinforce an association of the descriptor to the speech-identified inventory item and the speech-identified inventory event.

10. The computer-implemented method of claim 2, wherein
a recurrent neural network is used to train the speech machine learning classifier that classifies the speech as the descriptor of the speech-identified inventory item, and that classifies the speech as the descriptor of the speech-identified inventory event of the speech-identified inventory item.

11. The computer-implemented method of claim 2, wherein
a convolutional neural network is used to train the image machine learning classifier that classifies the detected object on the image as the image-identified inventory item, and that classifies the detected event as the image-identified inventory event of the image-identified inventory item.

12. The computer-implemented method of claim 2, wherein the wearable computing device is a badge including a housing that houses the microphone and camera.

13. The computer-implemented method of claim 2, wherein the wearable computing device communicates the image data and the audio data to a server computing device.

14. The computer-implemented method of claim 13, wherein the speech machine learning classifier and the image machine learning classifier are executed on the server computing device.

15. The computer-implemented method of claim 13, wherein the inventory program is executed on the server computing device.

16. A system for tracking inventory, the system comprising:
a wearable computing device comprising:
a processor;
a microphone operatively coupled to the processor; and
a camera operatively coupled to the processor, wherein the processor is configured to:
capture image data of an event including a series of images on the camera;
capture audio data of the event on the microphone;
perform speech recognition on the captured audio data to detect speech;
classify the speech using a speech classifier to determine that the event was an inventory event with a speech classification confidence value;
classify the image data using an image classifier to determine that the event was an inventory event with an image classification confidence value;
cross train the speech classifier based on the image classification confidence value and/or cross training the image classifier based on the speech classification confidence value; and
output the inventory event to an inventory program.

17. The system of claim 16, wherein
the image classifier is an image machine learning classifier configured to classify the object as an image-identified inventory item, and further to classify the event as an image-identified inventory event of the image-identified inventory item, thereby obtaining an image classification comprising the image-identified inventory item and the image-identified inventory event.

18. The system of claim 17, wherein
a convolutional neural network is used to train the image machine learning classifier that classifies the detected object on the image as the image-identified inventory item, and that classifies the detected event as the image-identified inventory event of the image-identified inventory item.

19. The system of claim 16, wherein
the speech classifier is a speech machine learning classifier configured to classify the speech as a descriptor of a speech-identified inventory item, and further to classify the speech as a descriptor of a speech-identified inventory event of the speech-identified inventory item, thereby obtaining a speech classification comprising the speech-identified inventory item and the speech-identified inventory event.

20. The system of claim 19, wherein
a recurrent neural network is used to train the speech machine learning classifier that classifies the speech as the descriptor of the speech-identified inventory item, and that classifies the speech as the descriptor of the speech-identified inventory event of the speech-identified inventory item.
